(19) United States
(12) Patent Application Publication
(10) Pub. No.: US 2010/0131326 A1
(43) Pub. Date: May 27, 2010

(54) IDENTIFYING A SERVICE ORIENTED ARCHITECTURE SHARED SERVICES PROJECT

(75) Inventors: Kishore Channabasavaiah, Palatine, IL (US); Stephen C. Kendrick, Fairfax, VA (US); Raghu Varadan, San Francisco, CA (US); Nevenko Zunic, Hopewell Junction, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/277,280

(22) Filed: Nov. 24, 2008

(51) Int. Cl. G06Q 10/00; G06N 5/02; G06F 7/06; G06F 17/30

(52) U.S. Cl. 705/9; 705/7; 706/46; 707/E17.014

(57) ABSTRACT

An approach that identifies a service oriented architecture (SOA) shared services project is provided. In one embodiment, there is a project identification tool, including an opportunity component configured to identify a SOA shared services opportunity. A project component is configured to identify a potential SOA shared services project based on the SOA shared services opportunity.

### CROSS-REFERENCE TO RELATED APPLICATIONS

The present application is related in some aspects to commonly owned and co-pending application entitled “Evaluating a Service Oriented Architecture Shared Services Project”, assigned attorney docket no. END920080288US1, which was filed on (to be provided), and was assigned application Ser. No. (to be provided), commonly owned and co-pending application entitled “Service Oriented Architecture Shared Service Inception”, assigned attorney docket no. END920080289US1, which was filed on (to be provided), and was assigned application Ser. No. (to be provided), commonly owned and co-pending application entitled “Service Oriented Architecture Shared Services Elaboration”, assigned attorney docket no. END920080290US1, which was filed on (to be provided), and was assigned application Ser. No. (to be provided), commonly owned and co-pending application entitled “Service Oriented Architecture Shared Services Construction”, assigned attorney docket no. END920080291US1, which was filed on (to be provided), and was assigned application Ser. No. (to be provided), commonly owned and co-pending application entitled “Transitioning to Management of a Service Oriented Architecture Shared Service”, assigned attorney docket no. END920080292US1, which was filed on (to be provided), and was assigned application Ser. No. (to be provided), commonly owned and co-pending application entitled “Service Oriented Architecture Shared Service Management”, assigned attorney docket no. END920080293US1, which was filed on (to be provided), and was assigned application Ser. No. (to be provided), commonly owned and co-pending application entitled “Service Oriented Architecture Shared Service Escalation”, assigned attorney docket no. END920080294US1, which was filed on (to be provided), and was assigned application Ser. No. (to be provided), the entire contents of which are herein incorporated by reference.

### FIELD OF THE INVENTION

This invention relates generally to lifecycle management and more specifically to the identification and management of SOA shared services.

### BACKGROUND OF THE INVENTION

In the past, software architectures have attempted to deal with increasing levels of software complexity. As the level of complexity continues to increase, traditional architectures are reaching the limit of their ability to deal with various problems. At the same time, traditional needs of information technology (IT) organizations persist. IT organizations need to respond quickly to new requirements of the business, while continuing to reduce the cost of IT to the business by absorbing and integrating new business partners, new business sets, etc.

Current IT lifecycle processes are configured to managing self-contained and siloed solutions. However, as businesses transition to service oriented architectures (SOA), traditional IT governance methods are inadequate at managing SOA shared services during their entire lifecycle. SOA is not a self-contained and siloed solution, rather it's a decomposition of solutions into a set of shared services. It is these SOA shared services that require a new lifecycle management system which takes into consideration multiple new processes that are not available or part of existing IT governance systems.

### SUMMARY OF THE INVENTION

In one embodiment, there is a method for identifying a service oriented architecture (SOA) shared services project. In this embodiment, the method comprises: identifying a SOA shared services opportunity; and identifying a potential SOA shared services project based on the SOA shared services opportunity.

In a second embodiment, there is a system for identifying a service oriented architecture (SOA) shared services project. In this embodiment, the system comprises at least one processing unit, and memory operably associated with the at least one processing unit. A project identification tool is storable in memory and executable by the at least one processing unit. The project identification tool comprises: an opportunity component configured to identify a SOA shared services opportunity; and a project component configured to identify a potential SOA shared services project based on the SOA shared services opportunity.

In a third embodiment, there is a computer-readable medium storing computer instructions, which when executed, enables a computer system to provide identification of a service oriented architecture (SOA) shared services project, the computer instructions comprising: identifying a SOA shared services opportunity; and identifying a potential SOA shared services project based on the SOA shared services opportunity.

In a fourth embodiment, there is a method for deploying a project identification tool for use in a computer system that provides identification of a service oriented architecture (SOA) shared services project. In this embodiment, a computer infrastructure is provided and is operable to: identify a SOA shared services opportunity; and identify a potential SOA shared services project based on the SOA shared services opportunity.

### BRIEF DESCRIPTION OF THE DRAWINGS

FIG. 1 shows a schematic of an exemplary computing environment in which elements of the present invention may operate;

FIG. 2 shows a flow diagram of a SOA services lifecycle management process;

FIG. 3 shows a project identification tool that operates in the environment shown in FIG. 1; and

FIG. 4 shows a flow diagram of a SOA services lifecycle management process for identifying a SOA shared services project.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to identifying a service oriented architecture (SOA) shared services project. In these embodiments, a project identification tool provides this capability. Specifically, the project identification tool comprises an opportunity component configured to identify a SOA shared services opportunity, and a project component configured to identify a SOA shared services project based on the SOA shared services opportunity. The project identification tool identifies and evaluates a shared services opportunity (e.g., a business need) and determines if the shared services opportunity can be met through the use of a SOA shared service.

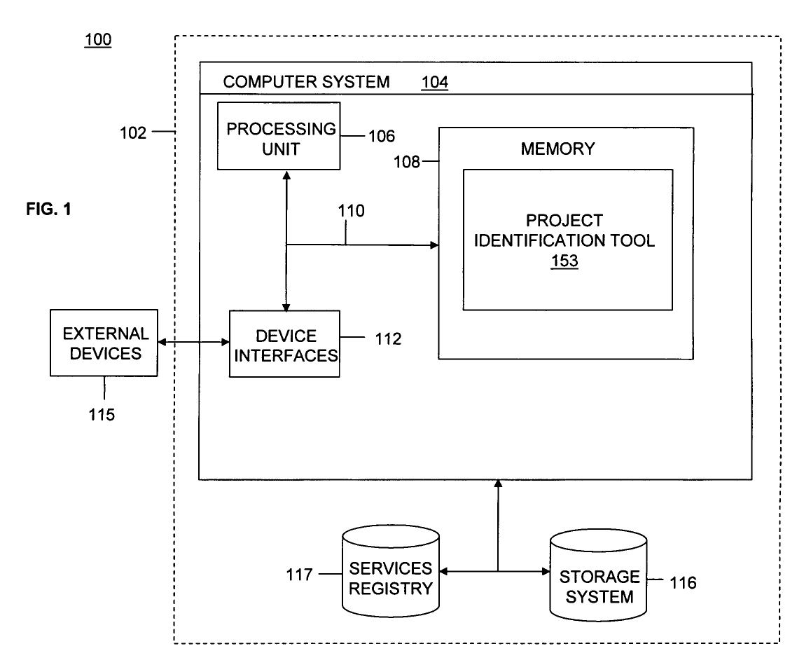

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for identifying a SOA shared services project. It should be understood that any other computers implemented under the present invention may have different components/software, but will perform similar functions. As shown, computer system 104 includes a processing unit 106, memory 108 for storing a project identification tool 153, a bus 110, and device interfaces 112.

Processing unit 106 collects and routes signals representing outputs from external devices 115 (e.g., a keyboard, a pointing device, a display, a graphical user interface, etc.) to project identification tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating project identification tool 153, which is stored in memory 108 and/or storage system 116. While executing computer program code, processing unit 106 can read and/or write data to/from memory 108, storage system 116, and a services registry 117. Services registry 117 stores a plurality of services and associated metadata, as well as rules against which the metadata is compared to locate shared services. Storage system 116 and services registry 117 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

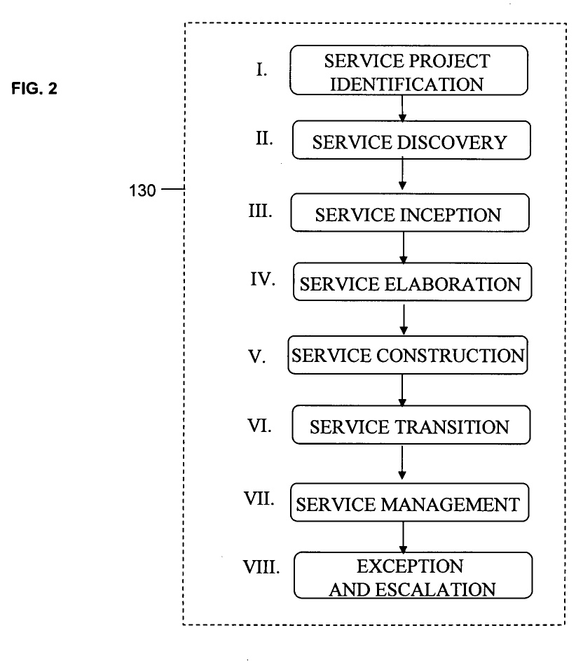

Implementation 100 and project identification tool 153 operate within a broader SOA services lifecycle management process (SLMP) 130, shown in FIG. 2, which identifies, implements, and manages a SOA shared service. SOA SMLP 130 provides guidance for managing the creation of shared services within an enterprise. Specifically, SOA SLMP 130 of the present invention includes new and distinct roles, governance checkpoints, increased collaboration requirements, and new decision control points. SOA SMLP 130 takes an extended view in identifying the various touch-points to plan, build and manage shared services. The initial process starts with the identification of a business initiative(s) having the potential of being a shared service candidate. The overall set of processes ends with the rollout of shared services fulfilling the identified business need, as well as management across its entire life.

SOA SLMP 130 of the present invention consists of the following distinct processes and associated methodologies:
I. New Service Opportunity Identification—the goal of this phase is to identify and evaluate a business need, and determine if the business need can be met through the use of SOA shared services.
II. Service Discovery—the goal of this phase is to complete the Discovery phase for a project that has been identified as a potential SOA services candidate project.
III. Service Inception—the goal of this phase is to gather the high level requirements for the SOA shared services that will be developed as part of the potential SOA services candidate project.
IV. Service Elaboration—the goal of this phase is to further define the high level requirements from the service inception phase into detailed requirements to complete the service solution design and prepare for the build phase.
V. Service Construction—the goal of this phase is to develop the integration components and integrate the SOA shared services components per the design guidelines while meeting/exceeding the necessary quality requirements so that the services can be deployed for general use.
VI. Service Transition—the goal of this phase is to transition the SOA shared services developed in the Construction phase to the operations team that will be responsible for ongoing SOA shared service maintenance.
VlI. Manage Services—the goal of this phase is to manage the SOA shared services once they have been transitioned to the operations team that will be responsible for ongoing SOA shared service maintenance.
VIII. Exception and Escalation—the goal of this phase is resolve issues that occur during the SOA services lifecycle process in an expedient manner.

Each of the above processes is a complete methodology that can be implemented independently since they define key stakeholders, affected processes, ownership, and touch-points throughout the organization. It will be appreciated that each of the above listed SOA processes are non-limiting examples of the functionality and operation of possible implementations of systems, methods and computer program products according to various embodiments of the present invention. In this regard, each process (I-VIII) may represent a module, segment, or portion of code, which comprises one or more executable instructions for implementing the specified logical function(s) of SOA SLMP 130, as shown in FIG. 2. It should also be noted that, in some alternative implementations, the functions noted in SOA SLMP 130 may occur out of the order listed above in processes I-VIII. For example, two processes shown in FIG. 2 in succession may, in fact, be executed substantially concurrently. It should also be noted that, in another alternative embodiment, additional or fewer process steps may be included in SOA SLMP 130. Further, each process of the flowchart of FIG. 2 can be implemented by special purpose hardware-based systems that perform the specified functions or acts.

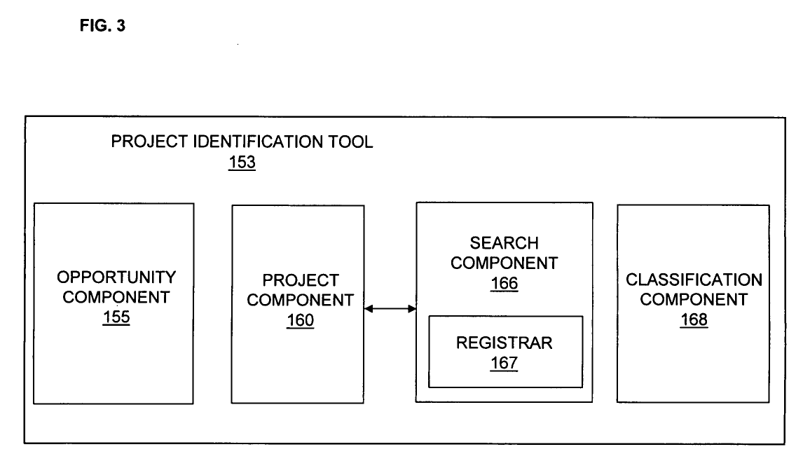

FIG. 3 shows a more detailed view of project identification tool 153, which identifies a SOA shared services project. As shown, project identification tool 153 comprises an opportunity component 155 configured to identify a SOA shared services opportunity. To accomplish this, business environments within an organization are scanned for any opportunities where a business service might provide customer value. A shared services opportunity may arise whenever there is a demand for integrated and composite applications that provide customer value. In one embodiment, a SOA shared services opportunity comprises a business need that is potentially resolved by a SOA shared service. The business need may be identified automatically by opportunity component 155, or provided as input by a user. Business needs may be identified and evaluated as part of an annual or other periodic project portfolio and prioritization review, or identified mid-year (e.g., due to a regulatory change).

In one embodiment, services registry 117 functions like a computerized portfolio or reference book containing information on available services. Business stakeholders can reference this portfolio as they interact with aspects of the IT architecture. For example, if a manager needs a certain business service performed, the manager may check services registry 117 to see if this service is currently performed elsewhere. In this example, the manager is then able to request access to the already-existing service. This sharing or re-use of services decreases redundancy and lowers cost.

Once a SOA shared services opportunity (i.e., business need) is identified, a plan or project is established, which attempts to address the SOA shared services opportunity. As shown in FIG. 3, identification tool 153 comprises a project component 160 configured to identify a potential SOA shared services project based on the SOA shared services opportunity. Specifically, project component 160 operates with a search component 166 to search the services registry 117 (FIG. 1) to identify at least one SOA shared service that can be re-used to address the business need identified by opportunity component 155. Registrar 167 provides the algorithm(s) necessary for searching metadata, which describes the characteristics of each service, as well as the data that drives them. Registrar 167 is configured to enable a flexible query to the services registry 117 based on the identified business need.

Once the potential SOA shared services project is identified, the project is analyzed to determine its scope. As shown in FIG. 3, project identification tool comprises a classification component 168 configured to classify the scope of the potential SOA shared services project. In one embodiment, the potential SOA shared services project is classified as either a “minor enhancement” project or a development lifecycle project. In the case that the project is classified as a minor enhancement project, the project is fast-tracked in terms of funding and prioritization. This will result in a quick build with decreased release times for enhancements that are low cost and low risk. Also, funding, prioritization, and ownership checkpoints are generally ignored for minor enhancement projects. If the project is classified as a development lifecycle project, it is entered into services registry 117, its status is updated, and the process proceeds to the service discovery step in SOA SLMP 130 (FIG. 2).

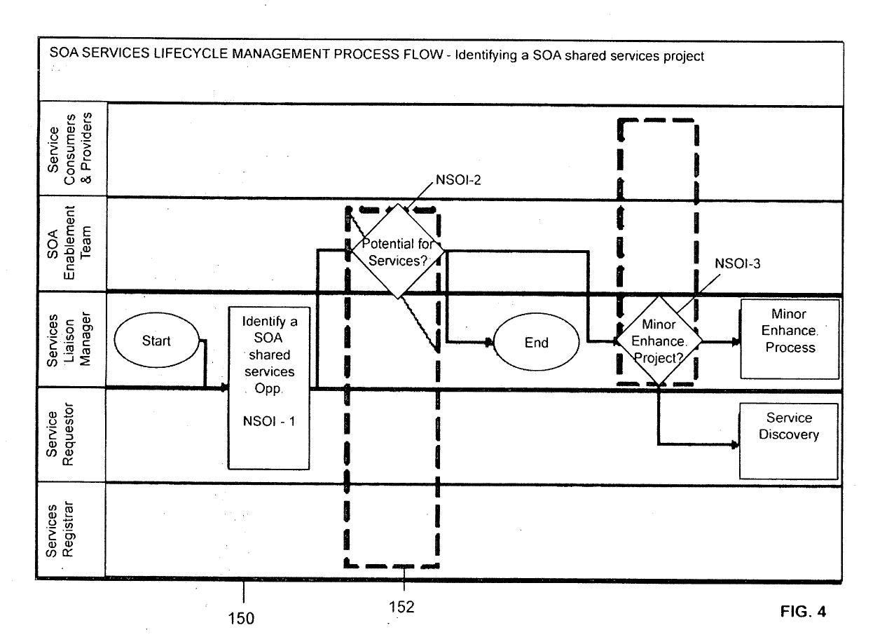

Referring now to FIG. 4, a SOA services lifecycle management process (SLMP) flow 150 for identifying a SOA shared services project will be described in further detail. As shown, the SOA SLMP flow 150 first identifies a SOA shared services opportunity at new services opportunity identification (NSOI)-1. Then at NSOI-2, it is determined whether there is a potential for shared services. As discussed above, project component 160 identifies a potential SOA shared services project based on the SOA shared services opportunity identified at NSOI-1. If there is potential for shared services, SOA SLMP flow 150 proceeds to NSOI-3, where the potential SOA shared services project is classified. If the project is determined to be a minor enhancement project, it is input to a minor enhancement process. If the project is determined to be a development lifecycle project, it is input to the service discovery step of SOA SLMP 130.

FIG. 4 also details the organizational roles and responsibilities for each entity in SOA SLMP flow 150. Specifically, project component 160 (FIG. 3) is configured to identify a set of responsibilities for each entity (i.e., services registrar, service requestor, services liaison manager, SOA enablement team, and service consumers and providers) associated with the potential SOA shared services project. For example, at NSOI-2, the SOA enablement team is considered to have primary responsibility for determining if there is potential for shared services. Each of the services registrar, service requestor and services liaison manager are considered to have secondary responsibility, as indicated by dashed-line 152. This may mean that the SOA enablement team is given authority and accountability to ultimately make the decision at NSOI-2. In this regard, SOA SLMP flow 150 governs the rules of engagement between the various entities. SOA SLMP flow 150 provides integration points between the various entities across different organizational domains involved in the development, integration, deployment and management of SOA shared services, as discussed herein.

It will be appreciated that SOA SLMP flow 150 of FIG. 4 represents one possible implementation of a process flow for identifying a SOA shared services project, and that other process flows are possible within the scope of the invention. SOA SLMP flow 150 illustrates the architecture, functionality, and operation of possible implementations of systems, methods and computer program products according to various embodiments of the present invention. In this regard, each portion of the flowchart may represent a module, segment, or portion of code, which comprises one or more executable instructions for implementing the specified logical function(s). It will also be noted that each block of the flowchart illustration can be implemented by special purpose hardware-based systems that perform the specified functions or acts.

The present invention provides an approach for identifying SOA shared services projects. In particular, the present invention includes a project identification tool comprising: an opportunity component configured to identify a SOA shared services opportunity, and a project component configured to identify a potential SOA shared services project based on the SOA shared services opportunity. In this way, the present invention provides the potential for a strategic level of alignment between, for example, IT domains and business domains of a business organization. This provides significant business benefits by using a SOA shared service to transform the business to better meet current business needs.

Further, it can be appreciated that the methodologies disclosed herein can be used within a computer system to provide identification of a SOA shared services project, as shown in FIG. 1. In this case, project identification tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for identifying a SOA shared services project. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for identifying a service oriented architecture (SOA) shared services project comprising:
identifying a SOA shared services opportunity; and
identifying a potential SOA shared services project based on the SOA shared services opportunity.

2. The method according to claim 1 further comprising classifying the scope of the potential SOA shared services project.

3. The method according to claim 1, the SOA shared services opportunity comprising a business need that is potentially resolved through the use of a SOA shared service.

4. The method according to claim 3, the identifying a potential SOA shared services project comprising searching a services registry to identify at least one SOA shared service that addresses the business need.

5. The method according to claim 1 further comprising identifying a set of responsibilities for each entity associated with the potential SOA shared services project.

6. A system for identifying a service oriented architecture (SOA) shared services project comprising:
at least one processing unit;
memory operably associated with the at least one processing unit; and
a project identification tool storable in memory and executable by the at least one processing unit, the project identification tool comprising:
an opportunity component configured to identify a SOA shared services opportunity; and
a project component configured to identify a potential SOA shared services project based on the SOA shared services opportunity.

7. The project identification tool according to claim 6 further comprising a classification component configured to classify the scope of the potential SOA shared services project.

8. The project identification tool according to claim 6, wherein the SOA shared services opportunity comprises a business need that is potentially resolved by a SOA shared service.

9. The project identification tool according to claim 8 further comprising a search component configured to search a services registry to identify at least one SOA shared service that addresses the business need.

10. The project identification tool according to claim 6, the project component further configured to identify a set of responsibilities for each entity associated with the potential SOA shared services project.

11. A computer-readable medium storing computer instructions, which when executed, enables a computer system to identify a service oriented architecture (SOA) shared services project, the computer instructions comprising:
identifying a SOA shared services opportunity; and
identifying a potential SOA shared services project based on the SOA shared services opportunity.

12. The computer-readable medium according to claim 11 further comprising computer instructions for classifying the scope of the potential SOA shared services project.

13. The computer-readable medium according to claim 11, the SOA shared services opportunity comprising a business need that is potentially resolved through the use of a SOA shared service.

14. The computer-readable medium according to claim 13, the computer instructions for identifying a potential SOA shared services project further comprising computer instructions for searching a services registry to identify at least one SOA shared service that addresses the business need.

15. The computer-readable medium according to claim 11 further comprising computer instructions for identifying a set of responsibilities for each entity associated with the potential SOA shared services project.

16. A method for deploying a project identification tool for use in a computer system that provides identification of a service oriented architecture (SOA) shared services project, comprising:
providing a computer infrastructure operable to:
identify a SOA shared services opportunity; and
identify a potential SOA shared services project based on the SOA shared services opportunity.

17. The method according to claim 16, the computer infrastructure further operable to classify the scope of the potential SOA shared services project.

18. The method according to claim 16, wherein the SOA shared services opportunity comprises a business need that is potentially resolved through the use of a SOA shared service.

19. The method according to claim 18, the computer infrastructure further operable to search a services registry to identify at least one SOA shared service that addresses the business need.

20. The method according to claim 16, the computer infrastructure further operable to identify a set of responsibilities for each entity associated with the potential SOA shared services project.
